(19) United States
(12) Patent Application Publication
(10) Pub. No.: US 2003/0235012 A1
(43) Pub. Date: Dec. 25, 2003

(54) Load torque variation preventing apparatus, magnetic disk apparatus, flat wiring cable and magnetic recording apparatus

(76) Inventor: Hiroshi Nishizawa, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/463,403

(22) Filed: Jun. 18, 2003

(30) Foreign Application Priority Data
Jun. 21, 2002 (JP) 2002-181704
Jul. 5, 2002 (JP) 2002-197432

(51) Int. Cl. G11B 5/55

(52) U.S. Cl. 360/264.2

(57) ABSTRACT

In a magnetic disk apparatus comprising a flexible printed circuit for supplying power to a magnetic head and a coil of a voice coil motor, included is a dummy flexible printed circuit having the same mechanical characteristic as that of the flexible printed circuit. The dummy flexible printed circuit and the flexible printed circuit are located at positions establishing an axial-symmetrical relation with respect to a line connecting a pivot bearing, which rotatably supports a suspension, with a center of the coil of the voice coil motor. With this construction, the variation of the load on the voice coil motor due to the dummy flexible printed circuit offsets the variation of the load on the voice coil motor due to the dummy flexible printed circuit.

### BACKGROUND OF THE INVENTION

1) Field of the Invention

The present invention relates to a magnetic disk apparatus to be used as an external storage apparatus for a personal computer or the like, and more particularly to a load torque variation preventing technique for use in a swing arm type voice coil motor (voice coil motor will hereinafter be referred to simply as “VCM”) for tracking or positioning a magnetic head in radial directions of a magnetic disk, and further to a flat wiring cable (flat cable) and a magnetic recording apparatus using the flat wiring cable.

2) Description of the Related Art

In general, a swing arm type VCM of a conventional magnetic disk apparatus is made up of an upper yoke, a lower yoke, magnets, a coil, a pivot bearing, and other components, and is mounted on a chassis of the magnetic disk apparatus. Moreover, an FPC (Flexible Printed Circuit) is employed for electrical connections between a magnetic head or a VCM coil and a circuit on a main body side. The VCM coil is energized through this FPC to position the swing arm type VCM for positioning the magnetic head toward a desired track, while data interchange is made through the FPC with respect to the magnetic head to carry out the recording/reproduction of required data.

In the recent years, the performance of the magnetic disk apparatus has increased owing to the size reduction and performance upgrading of a personal computer, while there exists requirements for a small-sized/high-capacity/fast/low-cost magnetic disk apparatus. Meanwhile, the conventional magnetic disk apparatus suffers from the following problems.

As mentioned above, the electrical connections between the main body side circuit section and the magnetic head/VCM depend upon the FPC, and in general, the FPC passes close to the pivot bearing of the VCM and is connected to the main body side circuit through the use of a stationary connector or the like. Therefore, the curvature of the FPC varies with the movement of the magnetic head due to the positioning motion of the VCM and, as a result, the load torque around the pivot bearing varies in accordance with the track position, which decreases the positioning accuracy of the magnetic head and causes a longer settling time.

As the countermeasures against these problems, the reduction of a load torque caused by the FPC has taken place through the employment of an expensive high-flexibility FPC, the invention of location thereof, or use of a complicated firmware. However, this increases the cost of parts themselves and deteriorates workability due to requirements for accuracy of the mounting or the like. In addition, the employment of the complicated firmware or the like causes an increase in development/design cost, and there is a need to secure a large memory capacity.

Meanwhile, a flat wiring cable (which will hereinafter be referred to as a “flat cable”) is constructed in a manner such that a non ionic copper (electrolytic-copper-made) thin plate is cut at a predetermined interval to produce a plurality of wiring conductors each having a required width and the wiring conductors are disposed on a plane in a parallel condition and coated with a thermoplastic resin, such as polyethylene terephthalate (PET), having flexibility. As the flat wiring means, there has been known a flexible wiring substrate made in a manner such that a cold rolled or non ionic copper plate foil is placed on a flexible substrate and only a conductor portion is left by means of etching. Since flat cable can be made at lower cost as compared to the flexible wiring substrate, the flat cable has been frequently used for electronic equipment.

However, the flexible wiring substrate has a higher flexibility than the flat cable. The flat cable shows higher flexibility in its perpendicular direction and shows lower flexibility in its width directions. For this reason, in a case in which connections are made through flat cables among connectors of a plurality of equipment, if the connector of each of the equipment is deviated into width direction of the flat cable, the connection flat cable with connectors will be deflected in the width direction so that a stress acts on each equipment, a substrate and a wiring conductor of the flat cable itself.

For overcoming this disadvantage, Japanese Patent Laid-Open No. HEI 6-36620 discloses a technique in which, as shown in FIGS. 18A and 18B, the flat cable 300 is bent at a plurality of portions to form a bellows structure 310 or 320, thereby enhancing the flexibility of the flat cable 300 in its width directions.

There is a problem of this conventional technique of bending and/or forming a flat cable several times for forming a bellows structure, however, in that the number of manufacturing steps increases due to the bending and the length of the flat cable itself is prolonged by a length corresponding to bending portions, which will increase manufacturing cost.

In addition, there is a possibility that a corrosion stress or the like occurs because a bending stress caused by the bending is applied, particularly, on the wiring conductor at all times, which decreases reliability.

Still additionally, the flat cable is also used, for example, for electrical connections of equipment mounted on a vehicle, portable equipment, or the like, thus requiring a damping characteristic for suppressing the propagation of vibrations to the equipment which is connected.

### SUMMARY OF THE INVENTION

The present invention has been developed with a view to eliminating these problems, and it is therefore an object of the invention to provide an apparatus with a simple construction capable of reducing the variation of load torque caused by the FPC.

Another object of the invention is to provide a low-cost and higher-performance magnetic disk apparatus equipped with this construction, which is capable of improving the track positioning accuracy.

A further object of the present invention is to provide a higher-reliability of flat wiring cable having a high flexibility in width directions and a vibration damping property, and enabling easy manufacturing.

For this purpose, in accordance with an aspect of the present invention, there is provided a load torque variation preventing apparatus for a voice coil motor which positions an actuator, supporting a magnetic head at its tip portion, around a pivot bearing, comprising a first FPC whose radius of curvature varies with an angle of rotation of the actuator and a second FPC which has the same mechanical characteristic as that of the first FPC and whose radius of curvature varies with an angle of rotation of the actuator, wherein a variation of load torque attendant upon a variation of radius of curvature of the second FPC with respect to the pivot bearing offsets or cancels a variation of load torque attendant upon a variation of radius of curvature of the first FPC with respect to the pivot bearing. This construction enables the second FPC to substantially eliminate the load torque with respect to the pivot bearing due to the first FPC, which allows higher-accuracy positioning through the use of a lower-cost FPC without employing a higher-flexibility and higher-cost FPC, thereby achieving the cost reduction.

In addition, according to another aspect of the present invention, the second FPC and the first FPC are located at positions establishing an axial- (line-) symmetrical relationship with respect to a line connecting the pivot bearing with a center of a coil of the voice coil motor. This enables the second FPC to certainly reduce the load torque occurring with respect to the pivot bearing due to the first FPC. Since they are located line-symmetrically, with respect to characteristics such as vibration proof other than the load torque, good balance is attainable.

Furthermore, in accordance with a further aspect of the present invention, there is provided a magnetic disk apparatus comprising a magnetic disk, a spindle motor for rotating the magnetic disk, a voice coil motor for positioning a magnetic head at its one end portion and having a coil at the other end portion for positioning the magnetic head toward a track of the magnetic disk with respect to a pivot bearing, and FPC means for supplying power to the voice coil motor and the magnetic head, wherein the FPC means includes a first FPC whose radius of curvature varies with a track position of the magnetic head and a second FPC which has equivalent mechanical characteristic to that of the first FPC and whose radius of curvature varies with a track position of the magnetic head, and a variation of load torque attendant upon a variation of radius of curvature of the second FPC with respect to the pivot bearing offsets a variation of load torque attendant upon a variation of radius of curvature of the first FPC with respect to the pivot bearing. This not only improves the positioning accuracy of the magnetic head without using a higher-cost higher-flexibility FPC, but also prevents an increase in development cost, and even eliminates the need for a large-capacity memory, thus realizing a magnetic disk apparatus with satisfactory characteristics at a low cost.

Moreover, according to a further aspect of the present invention, in the magnetic disk apparatus, the first FPC has a relatively wide pattern made to supply relatively large power and a relatively narrow pattern made to supply relatively small power, with the two types of patterns being isolated from each other to define a spacing with a predetermined width. With this construction, even if a relatively large power is supplied to the coil of the voice coil motor through the use of the relatively wide pattern, the noise induced in the relatively narrow pattern for supplying power to the magnetic head is reducible, thus providing a higher-quality reproduced signal and decreasing the occurrence of errors in the magnetic disk apparatus.

Still moreover, according to a further aspect of the present invention, in the magnetic disk apparatus, a dummy pattern is placed in the spacing. With this construction, the stray capacitances existing between the relatively wide pattern and the relatively narrow pattern are connected in series to each other by means of the dummy pattern, thereby reducing the stray capacitances and lessening the noise to be induced, which contributes to the improvement of the reliability of the magnetic disk apparatus.

Yet additionally, according to a further aspect of the present invention, a slit is made in the spacing and is filled with a visco-elastic material. With this construction, the visco-elastic material attenuates the vibrations occurring at the seek or the unnecessary vibrations from the external, which prevents the unnecessary transmission to the magnetic head, thereby shorting the settling time and enhancing the performance of the magnetic disk apparatus.

Furthermore, in accordance with a further aspect of the present invention, there is provided a flat wiring cable comprising a plurality of wiring conductors disposed on a plane in a parallel condition, a flexible insulator for covering a periphery of the plurality of wiring conductors, a slit made to pass through a portion of the flexible insulator between the wiring conductors and to extend in parallel with the wiring conductors, and a visco-elastic material put in the slit.

This construction enables better flexibility of the flat wiring cable in direction (width directions) perpendicular to the slit, and improves the damping property due to the visco-elastic material put in the slit. Since this flat wiring cable does not require the bellows structure in comparison with the conventional technique, an increase in cost and a decrease in reliability is preventable.

Still furthermore, in accordance with a further aspect of the present invention, there is provided a magnetic recording apparatus in which a circuit substrate for conversion of an interface signal and a base of the magnetic recording apparatus are connected to each other through the above-mentioned flat wiring cable.

With this construction, even if a displacement of the flat wiring cable occurs due to the occurrence of a deviation between the magnetic recording apparatus base and the circuit substrate, since the flat wiring cable has a high flexibility in its width directions, it is possible to minimize off track value of the magnetic recording apparatus in track directions. Moreover, owing to the high flexibility, the high reliability is maintainable even if the magnetic recording apparatus is mounted on a vehicle or is used as portable equipment.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is a plan view showing an essential part of a hard disk drive (hereinafter called HDD) (magnetic disk apparatus) according to a first embodiment of the present invention;

FIG. 2 is a cross-sectional view showing a pivot bearing of a VCM in the HDD according to the first embodiment;

FIG. 3 is an illustration useful for explaining a load torque generated by an FPC in the HDD according to the first embodiment;

FIG. 4 is an illustration useful for explaining the positioning accuracy of a magnetic head of the HDD according to the present invention;

FIG. 5 is a perspective view showing an essential construction of the FPC in the HDD according to the first embodiment;

FIG. 6 is a perspective view showing an essential construction of the FPC in the HDD according to the first embodiment;

FIG. 7 is a perspective view showing an essential construction of the FPC in the HDD according to the first embodiment;

FIG. 8 is an illustration useful for explaining a transfer gain characteristic of the VCM according to the first embodiment;

FIG. 9 is an illustration of disturbance and a positioning characteristic in the HDD according to the first embodiment;

FIG. 10 is a perspective view showing a flat wiring cable according to a second embodiment of the present invention;

FIG. 11 is a perspective view showing the flat wiring cable flexed and displaced in a width direction;

FIG. 12 is a perspective view showing the flat wiring cable from which an upper-side insulating film is removed;

FIG. 13 is an enlarged perspective view showing a slit and its periphery of the flat wiring cable;

FIG. 14 is an illustration of displacement-load characteristics when various flat wiring cables are placed in flexed conditions;

FIG. 15 is an illustration useful for explaining a method of measuring the characteristic shown in FIG. 14;

FIG. 16 is a plan view showing an essential part of a magnetic recording apparatus body according to a third embodiment of the present invention;

FIG. 17 is a perspective view showing an essential part of the magnetic recording apparatus according to the third embodiment; and

FIGS. 18A and 18B are illustrations of a conventional flat wiring cable.

### DESCRIPTION OF THE PREFERRED EMBODIMENTS

Embodiments of the present invention will be described hereinbelow with reference to the drawings.

(First Embodiment)

First of all, referring to FIG. 1, a description will be given hereinbelow of a construction of a magnetic disk apparatus according to a first embodiment of the present invention. FIG. 1 is a plan view showing an essential part of the HDD according to the first embodiment. A section of the HDD other than a circuit section will hereinafter be referred to as an “HDA (Head Disk Assembly)”.

In FIG. 1, the HDA, generally designated at reference numeral 1, is equipped with a metal-made, for example, aluminum-made, chassis 2 having a generally box-like configuration and a cover (not shown) for covering an upper portion of the chassis 2. in the interior of the HDA 1, there is located a magnetic disk 10 serving as a magnetic recording medium made such that a magnetic thin film, such. as a Co—Cr-based film, is formed on a non-magnetic substrate material such as aluminum or glass by means of sputtering or the like, and a required protective film and lubricant layer are formed thereon. A spindle motor 14 located below the disk 10 is made to rotate the disk at a constant speed. The bearing for the spindle motor 14 is a dynamic fluid type of bearing, and the motor is a radial gap type of DD motor. Thus, the disk 10 is rotatable with high rotational accuracy. With respect to the radial run-out of the disk 10, the magnetic disk apparatus is designed to satisfy the requirements for high accuracy, prescribed by the RRO (Repeatable Run-Out)/NRRO (Non Repeatable Run-Out) or the like.

A magnetic head 7, made to carry out the recording/reproduction of information on/from the disk 10, is supportably attached to a gimbal spring (not shown) at a tip portion of a suspension 6, and is made to receive a loading force through a load beam (not shown). In the magnetic head 7, a thin-film head for writing and a GMR (Giant Magneto Resistance) head for reading are mounted on a slider (not shown), and the slider is of a negative pressure type having a pair of ABSs (Air Bearing Surfaces) formed into a required configuration.

The suspension 6 is supported by a pivot bearing 5 to be rotatable in track directions (in radial directions) of the disk 10. An actuator, being composed of the suspension 6 and a coil arm 8, is rotated and positioned by a VCM to rotate and position the magnetic head 7 in the track directions. A ramp 3 is placed at an actuator retreating (park) position on an outer circumferential side of the disk 10, and the actuator is unloaded at the retreating position when the HDD falls into a standby condition, and is held at the retreating position while the HDD is in a non-operating condition. A circuit board on which mounted are a drive circuit for controlling the operations of motors or the like, an R/W (Read/Write) circuit, an HDC (Hard Disk Controller), not shown, and others is fixedly secured to a lower surface of the chassis 2, thereby forming an HDD. This HDD has a load/unload mechanism. When the HDD is activated, the disk 10 is rotated by the spindle motor 14, and when the HDD falls into an inoperative condition, the disk 10 is stopped by the spindle motor 14. Tracks for recording data and servo information are concentrically formed on a surface of the disk 10. The tracks are more finely divided into sectors in units of 512 bytes, and the zone bit recording method is employed so that the track recording density become approximately constant.

The coil arm 8 and the suspension 6 are supported by the pivot bearing 5 to be rotatable, and are located in opposite positional relation with respect to the pivot bearing 5, and a tab 11 whereby the actuator is retreated onto the ramp 3 is placed at the tip portion of the suspension 6. The tab 11 is a portion to be held by the ramp 3 when shifted up to the retreating position, and has a protruding portion (not shown) brought into contact with the ramp 3. This protruding portion reduces the friction with the ramp 3 to prevent the contamination and further for preventing the contact with the disk 10 due to a variation of posture of the magnetic head 7 at the time of the shifting from the disk 10 to the retreating position and vice versa.

In this embodiment, the HDA is referred to as 1-platter 1-head, and only the upper surface of the disk 10 is employed as a recording surface and one magnetic head 7 is put to use. The magnetic head 7 records data onto the disk 10 through an electric circuit (not shown), or reads out recorded data from the disk 10. For the recording, the code conversion is made in units of bytes through the use of the 16-17 modulation mode (16-bit data is converted into 17-bit data and recorded), thus realizing the increase of the storage capacity and the improvement of the recording/reproduction characteristics. These signals are interchanged through an FPC (Flexible Printed Circuit) with respect to the magnetic head 7, and are connected to the main circuit through a stationary connector. In the FPC 12, there are two signal lines for supplying a write current to a writing thin-film head, two signal lines for supplying a sense current to a reading GMR head, and two lines for supplying relatively large power to the VCM coil, which form at least six lines. Meanwhile, a dummy FPC 12A, having the same mechanical characteristic as that of the FPC 12, is provided separately from the FPC 12, and the FPC 12 and the dummy FPC 12A are located axial-symmetrically with respect to a line connecting the pivot bearing 5 and the center of the coil 9, as shown in FIG. 1.

In this embodiment, the dummy FPC 12A has the same configuration as that of the FPC 12 and has the same mechanical characteristic as that of the FPC 12. In the construction of the FPC 12, a polyimide film with a thickness of 0.5 Mil (25 μm) is used as a base film and a cover film, and a rolled copper foil of 0.5 Oz (18 μm) is used as an electric conductor.

The magnetic head 7 is attached to a slider and is biased toward the disk 10 by a loading force given by the suspension 6. As mentioned above, the slider is a negative pressure type of slider having a pair of ABS surfaces formed into a required configuration, and owing to the occurrence of given positive/negative pressures stemming from an air flow occurring due to the rotation of the disk 10, the magnetic head 10 is made to flying stably by a very slight flying height (10 to 30 nm).

The VCM is made up of the coil 9, upper and lower yokes (not shown), and a magnet 13. On a lower end surface of the coil 9 fixed to the coil arm 8 of the actuator, the magnet 13 is disposed through a predetermined gap in opposed relation thereto. The magnet 13 is fixedly secured to the lower yoke. Above the coil 9, the upper yoke is disposed through a predetermined gap in opposed relation thereto. This construction establishes a magnetic circuit, and the coil arm 8 is placed in a space sandwiched between the upper yoke and the magnet 13 so that the coil 9 is rotatable. The magnet 13 is made of an Nd—Fe-based sintered type having a high energy product, with its surface being rustproofed by Ni plating or the like, and magnetized into two poles in plane.

Although not shown, the ramp 3 has a composite plane comprising oblique and flat surfaces corresponding to the tab 11 and others, with the composite plane being disposed in a moving direction of the tab 11 related to a rocking action of the suspension 6 at unloading, that is, in a state directed at the outer side of the disk 10 in its radial direction, and fixedly secured to the chassis 2. The actuator, the VCM and the ramp 3 constitute a load/unload mechanism.

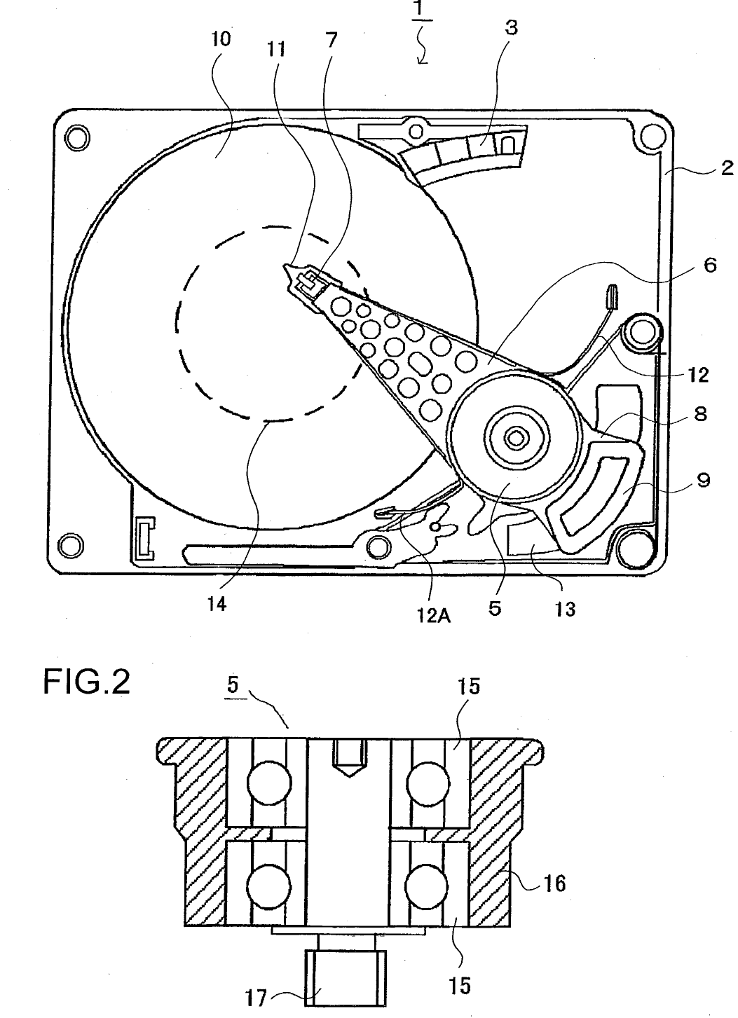

As FIG. 2 shows, the pivot bearing 5 is preloaded using two deep-groove type radial bearings 15. A collar 16 is attached to an outer ring of the radial bearings 15, and the suspension 6 shown in FIG. 1 is fixedly secured thereto, and a screw 17 is placed along the axis to fix the pivot bearing 5 to the chassis 2 shown in FIG. 2. Thus, it can be rotated with a small rotating torque and the run-out thereof becomes an extremely small value.

A description will be given hereinbelow of an operation of the HDD. The spindle motor 14 is driven through the circuit substrate so that the disk 10 is rotated at a predetermined rotation speed. In this embodiment, the rotational speed is set at 50S⁻¹ (3,000 rpm) . The magnetic head 7 retreated at the ramp 3 is rotationally driven around the pivot shaft 5 by the VCM to load the magnetic head 7 onto an upper surface of the disk 10. An air flow stemming from the rotation of the disk 10 passes between the slider and the disk 10 so that the slider floats stably by a very slight flying height (10 to 30 μm) with respect to the disk 10 against the loading force of the suspension 6, and the loading of the magnetic head 7 reaches completion. Subsequently, the track information and others are read out thereby, then followed by the implementation of a series of operations such as track recognition, called acquire.

When the coil 9 of the VCM is energized, the VCM generates a torque due to a magnetic flux from the magnet 13 and a current flowing through the coil 9 according to the Fleming's left-hand rule. Because the magnet 13 is in a fixed state, the coil 9 generates the torque as a reaction to revolve the actuator around the pivot bearing 5. Thus, the actuator is rotated by an angle corresponding to an energizing current of the coil 9. The magnetic head 7 supported by the suspension 66 is shifted in a flying state over the disk 10 in a radial direction of the disk 10, and is positioned with respect to a desired track to carry out the information recording/reproduction on/from the disk 10.

For reducing the variation in torque, the mounting of the magnet 13 with respect to the center of rotation of the pivot bearing is done to satisfy a required accuracy. This is for avoiding the dispersion of the magnetic flux passing through the coil 9. Moreover, this is because the generation of a torque is based on the B·I·L (magnetic flux×current×length) rule.

The radius of curvature of the FPC 12 varies in accordance with the track position related to the rotational movement of the VCM. Accordingly, the bending stress varies and the load on the VCM varies due to the reactive force. That is, the torque of the VCM behaves as if it varies in accordance with its position in a rotating direction. So far, for coping with the load variation, the conventional techniques are, for example, that the value of current to be supplied to a coil has been adjusted on the basis of the track position, that the gain adjustment on a servo loop, or the like, is made for each HDA, or that a step of adjusting current is introduced into a firmware. Moreover, for reducing the load torque from the FPC, for example, an expensive high-flexibility FPC is put to use.

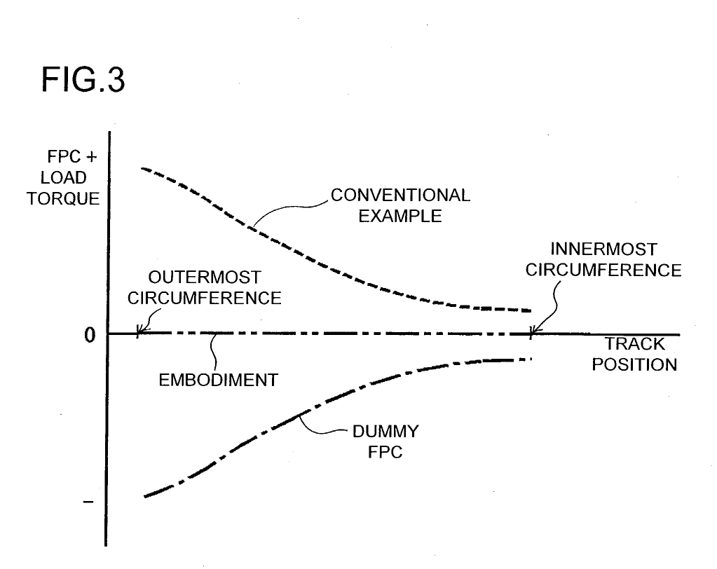

In this embodiment, the variation of the load torque from the FPC 12 can be canceled by the variation of the load due to the dummy FPC 12A, thus easily and completely solving such problems. This solution to the problems will be described hereinbelow with reference to FIG. 3. In FIG. 3, the horizontal axis represents a track position while the vertical axis depicts a load torque due to the FPC, and the sign + signifies a direction of the magnetic head 7 being shifted toward an inner circumferential side of the disk 10. In the case of a conventional technique, as indicated by a dashed line in the illustration, a load torque develops while varying in accordance with the track position. This is because the FPC 12 is located on the HDA 1 in a bent condition as shown in FIG. 1. That is, the FPC 12 generates a force in a direction of coming into a linear condition (of eliminating the bent condition) and, hence, a load torque develops around the pivot bearing 5 in a direction of the magnetic head 7 being shifted toward the inner track of the disk 10. On the other hand, according to this embodiment, the dummy FPC 12A having a mechanical characteristic equivalent to that of the FPC 12 is placed to be in axial-symmetrical relation to the FPC 12 with respect to a line connecting the pivot bearing 5 and the center of the coil 9 of the VCM. In the illustration, a load developing due to the dummy FPC 12A is indicated by a long dashed short dashed line. Since the dummy FPC 12A has the same mechanical characteristic as that of the FPC 12, it acts conversely with respect to the FPC 12 and, hence, the load torques due to the two FPCs cancel or offset each other, thereby offering the characteristic according to this embodiment indicated by a long dashed double-short dashed line in the illustration. It is seen from this that the load torque variation is eliminable irrespective of the track position and the load torque is extremely reducible. These effects are achievable provided that the FPC 12 and the dummy FPC 12A have mechanical characteristics equivalent to each other, without using an expensive high-flexibility FPC. In addition, even if the variation of curvature, i.e., the load torque variation related to the track position, is more complicated as compared with the case mentioned in this embodiment, similar effects are also obtainable.

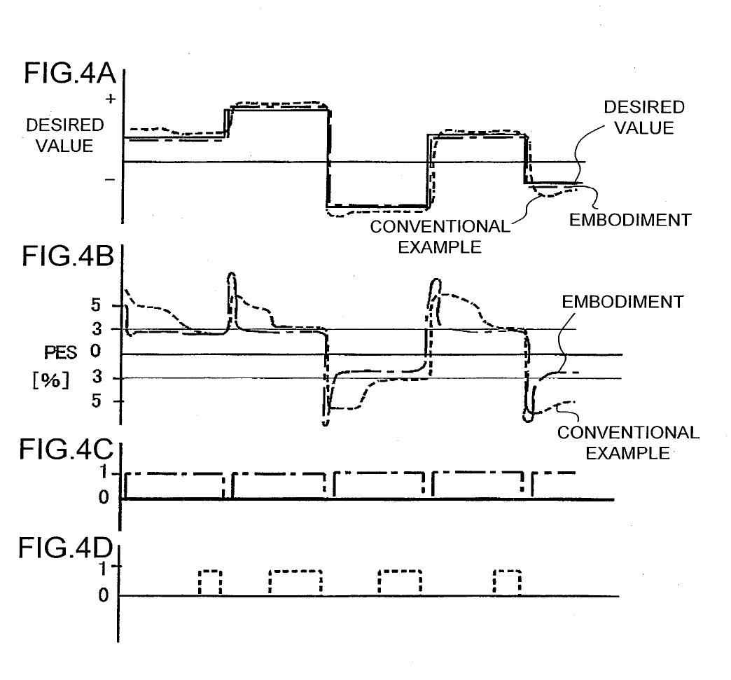

Furthermore, referring to FIGS. 4A to 4D, a description will be given hereinbelow of characteristics on positioning accuracy in an actual HDD. In these illustrations, the horizontal axis represents the passage of time. In FIG. 4A, a continuous line denotes a desired value in shifting the magnetic head 7, a long dashed short dashed line denotes a shifting state according to this embodiment, and a dashed line denotes a shifting state of a conventional example. In FIG. 4B, the vertical axis represents a PES (Position Error Signal) when a head moves actually. The PES signal usually uses a value obtained by normalizing a positional deviation quantity of a magnetic head in a track direction with respect to a track pitch, and it is known that a value of approximately 5 to 7% is acceptable for the readout while a value below approximately 3% is acceptable for the writing. That is, the PES serves as an index for making a judgment on the fact that the magnetic head reaches a readable/writable positioning condition. Therefore, according to the index, the HDD is more excellent as this access time is shorter. In FIG. 4C, on the vertical axis, a writable state time according to this embodiment is shown as a level 1, and in FIG. 4D, on the vertical axis, the writable state time according to a conventional example is indicated as a level 1. These correspond to a state in which the value of the PES signal is below 3% in FIG. 4B. The writable state signifies the readable state, and it can be considered that they represent a time available after the seek of the HDD. As seen from FIG. 4C, according to this embodiment, writable and readable states are attainable immediately after the seek. That is, it provides short access time, which contributes to the improvement of performance of the HDD. This is because the reduction of the load torque caused by the FPC 12 enables the magnetic head 7 to behave in conjunction with a supply current to the VCM according to a swing instruction for a desired value. In other words, the shortening of the access time is also feasible even using a conventional VCM, thus realizing a high-performance HDD. Moreover, it is possible to eliminate the need for the adjustment of the value of a current flowing through a coil in connection with a track position, the gain adjustment of a servo loop for each HDA, the implementation of a current adjustment step in a firmware, and others.

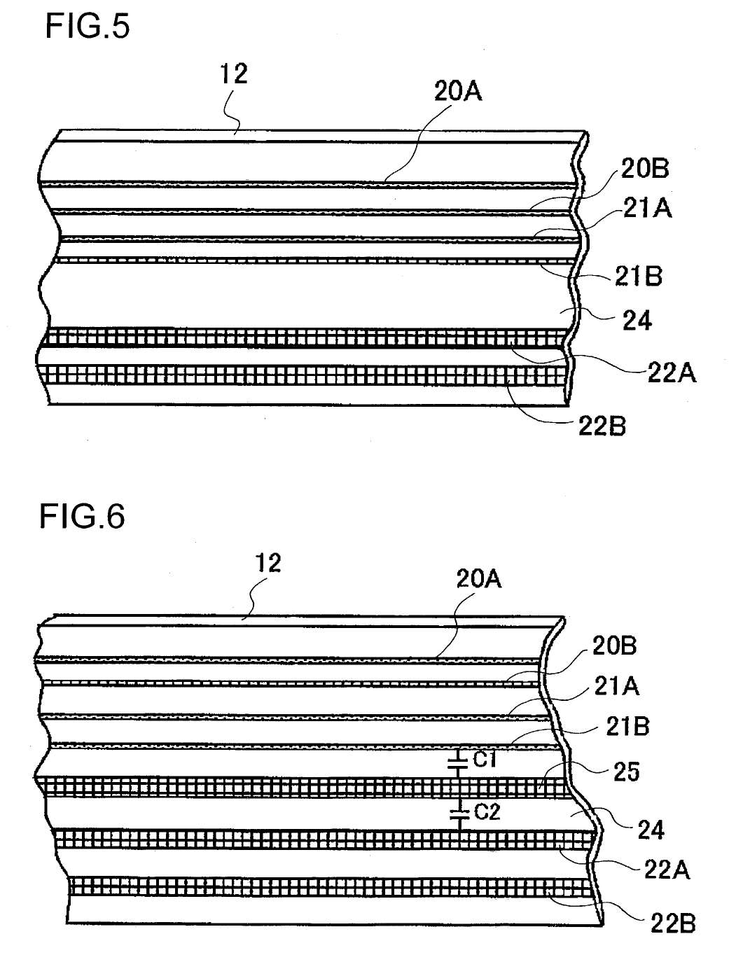

Furthermore, referring to FIGS. 5 to 9, a description will be given hereinbelow of examples of construction of the FPC 12. In FIG. 5, the FPC 12 comprises at least six patterns including two signal lines 20A and 20B for supplying sense current to a read GMR head, two signal lines 21A and 21B for supplying write current to a write thin-film head, and two feed lines 22A and 22B for supplying relatively large electric power to the coil 9 for the VCM. Each of the four signal lines 20A, 20B, 21A and 21B is constructed in the form of a signal line pattern having a relatively small width (0.1 mm) to feed relatively small electric power to the magnetic head 7, while each of the two feed lines 22A and 22B is made as a pattern having a relatively large width (0.3 mm) to feed relatively large electric power to the coil 9 of the VCM. Moreover, between the two types of patterns different in width, there is defined a spacing 24 having a relatively large width. This spacing 24 is made to be 0.5 mm in width. Naturally, this width can properly be altered in accordance with the magnetic head 7 or VCM to be put to use. Still moreover, because of handling a very small signal to the read GMR head, the signal lines 20A and 20B are disposed to be separated at furthest from the feed lines 22A and 22B for the coil 9 of the VCM.

This construction can prevent the degradation of a readout signal (S/N ratio) from the GMR head due to noise generated in conjunction with a supply current to the VCM for controlling the position of the magnetic head 7 because of slight eccentricity of a track at the time of the seek or after the seek. The noise superimposed on the readout signal is in inverse proportion to the square of distance and, for this reason, it is desirable that the width of the spacing 24 is set to be as large as possible. So far, for enlarging this spacing, there has been a need to increase the dimension of the FPC in its width directions. However, since the load torque of the FPC increases adversely, the so-called trade-off has been made between the noise and the load torque for optimization. According to this embodiment, it is possible to sufficiently secure the spacing without increasing the dimension of the FPC in its width directions, which enables the error rate reduction.

In an example of construction shown in FIG. 6, a dummy pattern 25 is formed in the above-mentioned relatively wide spacing 24. With this construction, assuming that the stray capacitance developing between the dummy pattern 25 and the relatively narrow pattern 21B adjacent thereto is taken as C1 and the stray capacitance developing between the dummy pattern 25 and the relatively wide pattern 22A adjacent thereto is taken as C2, the stray capacitances C1 and C2 are connected in series to each other by the dummy pattern 25. Therefore, the composite stray capacitance is reduced to (C1·C2)/(C1+C2), thus further reducing the noise to be induced. Moreover, since the signal lines 20A and 20B extending to the read GMR head and handling a very small signal are disposed to be separated at furthest from the feed lines 22A and 22B for the coil 9 of the VCM, the noise in the section corresponding to the stray capacitance C1 is considerably reducible, which lessens the influence of the noise from the VCM. Moreover, with this construction, as compared with the construction example shown in FIG. 5, the spacing 24 can be made narrower so that the width of the FPC 12 is reducible, which increases the number of FPCs 12 per unit area to contribute to the cost reduction. The other construction and operation are similar to those shown in FIG. 5, and the description thereof will be omitted for brevity.

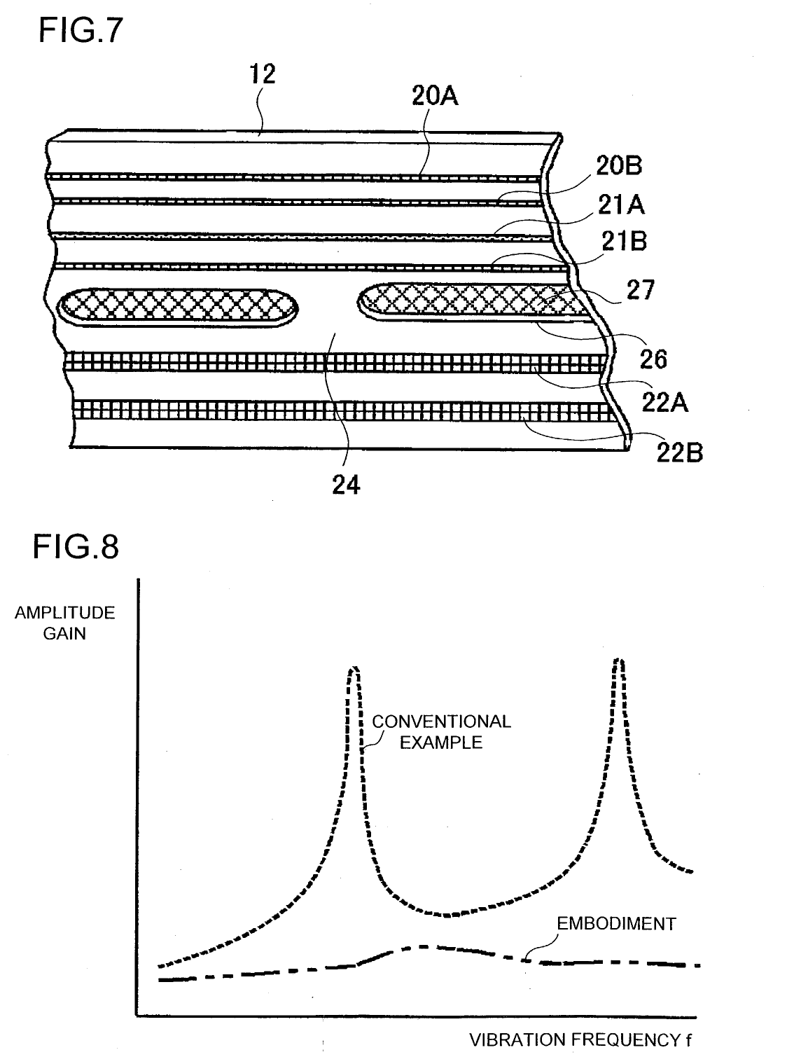

In an example of construction shown in FIG. 7, slits 26 are made in the above-mentioned relatively wide spacing 24, and are filled with a visco-elastic material 27. The dimension of each of the slits 26 is set to be 0.3 mm in width and approximately 5 mm in length, and the slits 26 are made at an interval of 8 mm. With this construction, the visco-elastic material 27 can attenuate the unnecessary vibrations occurring at the time of the seek or coming from the external, thereby preventing the propagation of the unnecessary vibrations to the magnetic head 7.

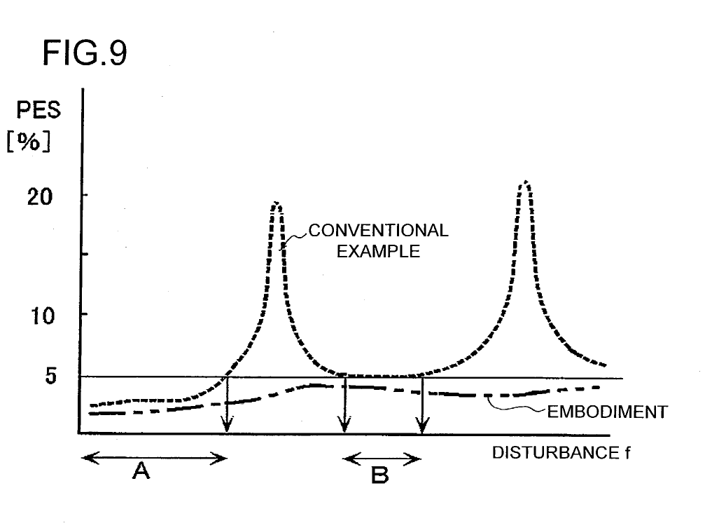

This characteristic will further be described with reference to FIGS. 8 and 9. In these illustrations, there are shown characteristic examples measured in a case in which a G having a constant value is applied thereto. In FIG. 8, the horizontal axis represents a frequency f of disturbance or vibration, while the vertical axis indicates a gain of transfer function around a pivot bearing. In FIG. 9, the horizontal axis represents a frequency f of disturbance, while the vertical axis indicates a PES. In these illustrations, broken lines denote a case of a conventional example, while long dashed double-short dashed lines depict a case of this embodiment. As seen from these illustrations that, according to this embodiment, it is possible to provide lower amplitude gain and PES characteristics. This may be because the visco-elastic material 27 put in the slits 26 acts as a viscous damper and the FPC 12 and the dummy FPC 12A decrease the mass-visco-elastic vibrations apparently to improve the conventional spring-mass system vibrations. If, as mentioned above, the PES is set to be 5% which permits readout, in the case of the conventional example, only the zones indicated by characters A and B in FIG. 9 allow the readout. On the other hand, according to this embodiment, the readout can be done throughout, which enhances the performance of the magnetic disk apparatus.

In the above-described embodiment, although one of the two FPCs is made as a dummy, it is also appropriate that the two FPCs are constructed as a normal FPC without making a dummy.

(Second Embodiment)

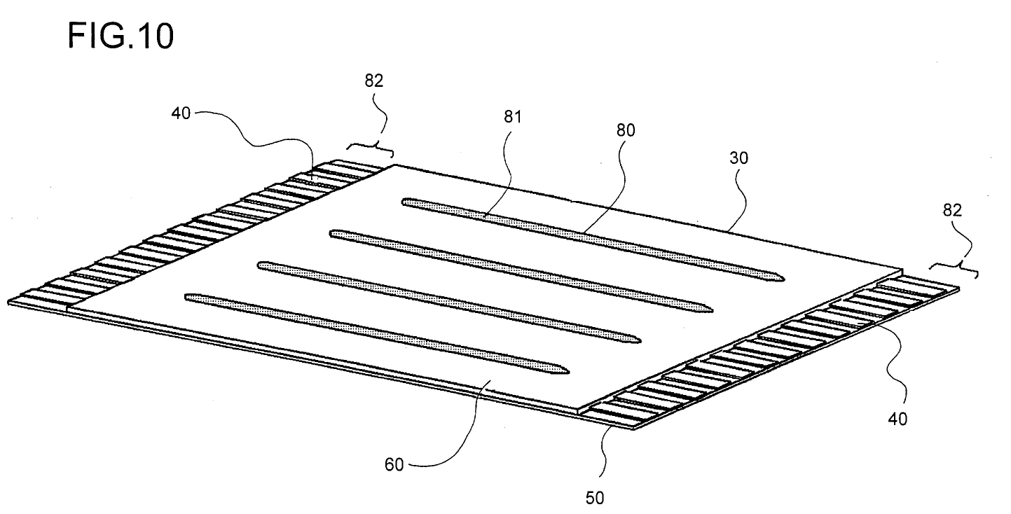

A description will be given hereinbelow of a flat-plate-like wiring cable (which will be referred to hereinafter as a “flat cable”) according to a second embodiment of the present invention. FIG. 10 is a perspective view showing the flat cable according to the second embodiment.

In FIG. 10, the flat cable 30 is made up of a plurality of wiring conductors 40, a lower insulating film 50 and upper insulating film 60 which sandwich the wiring conductors 40 therebetween, a plurality of slits 80 penetrating the upper and lower insulating films 60 and 50, and a visco-elastic material 81 put in the slits 80.

Each of the upper and lower insulating films 60 and 50 is made of a thermoplastic resin, such as polyethylene terephthalate (which will hereinafter be referred to simply as “PET), having flexibility. In this embodiment, the thickness of each of the upper and lower insulating films is set to be 0.025 mm.

The wiring conductors 40 are formed in a manner such that tin-plating or the like is made on a thin place such as a rectangular annealed copper wire and the thin foil is cut into parts each having a required width and length. In this embodiment, each of the wiring conductors 40 is set to be 0.025 mm in thickness and 0.3 mm in width. The thickness is properly determined taking into consideration a current-carrying capacity to be used, the flexibility in thickness directions, and others.

The plurality of wiring conductors 40 are disposed at an equal interval and the lower and upper insulating films 50 and 60 are thermally adhered (laminated) to the plurality of wiring conductors 40 to electrically insulate the wiring conductors 20. In this embodiment, the pitch of the wiring conductors 40 is set to be 0.5 mm.

Each of the slits 80 is made to pass through the upper and lower insulating films 60 and 50, and is made to extend along the longitudinal direction of the flat cable 30 but it does not reach end portions thereof. The plurality of slits 80 are disposed at an equal interval in width directions (directions perpendicular to the slits 80) of the flat cable 30. In this case, the slits 80 made are four in number. These slits 80 are filled with a visco-elastic material 81. As the visco-elastic material 81 available, there are butyl-based rubbers, silicone rubbers, high-damping rubbers, sorbothane (registered trademark: Sanshin Kosan Co., Ltd), αgel (registered trademark: GELTEC Co., Ltd.), polystyrene gel, and others.

At both end portions of the flat cable 30 in its longitudinal directions, the wiring conductors 40 are exposed to form terminal portions 82. Each of the terminal portions 82 is connected to a land or connector for electrical connection. In this connection, in the case of the connection using solder or the like, it is preferable that the upper and lower insulating films 60 and 50 are removed to fully expose the wiring conductors 40 of the terminal portions 82. Moreover, in the case of the connection using a connector, it is preferable that, as shown in FIG. 10, the insulating film 50 on the opposite side to the surface on which the wiring conductors 40 of the terminal portions 82 are in an exposed condition is left and a film (PET) with an appropriate thickness is adhered (backed) onto the rear surface of this insulating film 50 so that the cross-sectional configuration of the terminal portions 82 is fit for an insertion opening of a connector.

This flat cable 30 is electrically connected through its terminal portions 82 to equipment to carry out the transmission of electric signals, the supply of power and others through the wiring conductors 40.

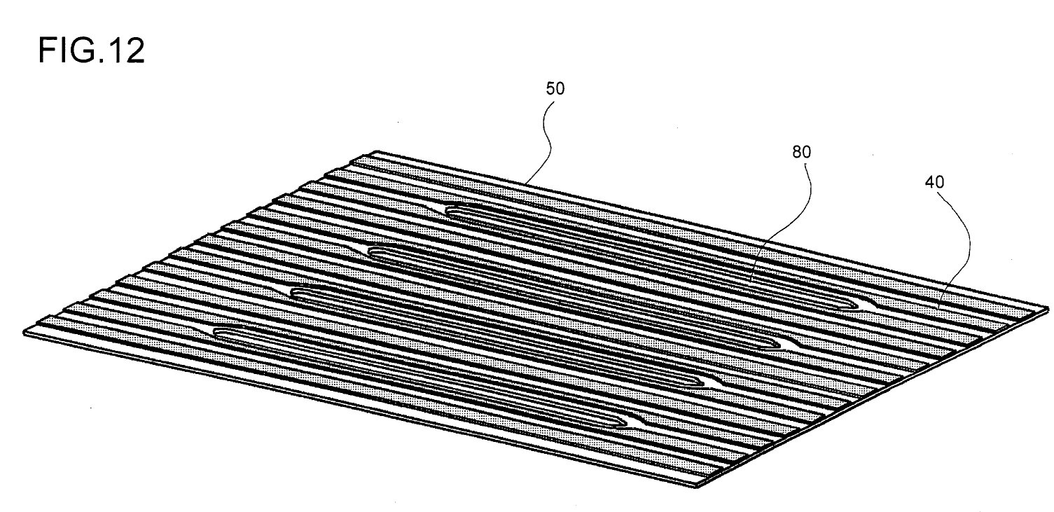

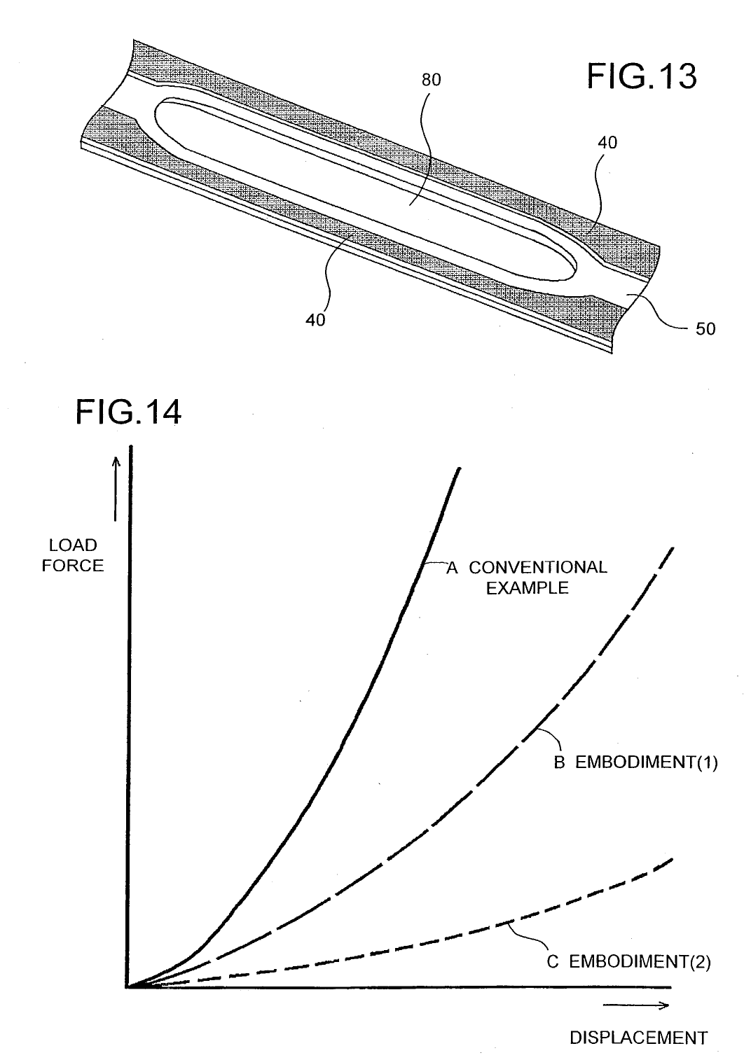

FIG. 12 shows a state in which the upper insulating film 60 is removed from the flat cable 30, and FIG. 13 is an enlarged illustration of the slit 80 shown in FIG. 12. The width of the wiring conductors 40 adjacent to the slit 80 is narrowed to the slit 80. That is, each of the wiring conductors 40 in the vicinity of the slit 80 is made such that a width of a portion adjacent to the slit 80 is narrower than a width of a portion which is not adjacent to the slit 80.

The flat cable 30 is produced in a manner such that the wiring conductors 40 are sandwiched (laminated) between the lower insulating film 50 and the upper insulating film 60 and the slits 80 are made by means of punching or the like and are filled with the visco-elastic material 81.

Incidentally, it is also appropriate that the slits 80 are made in the upper and lower insulating films 60 and 50 and the wiring conductors 40 are sandwiched between these films 60 and 50. In this case, because of the employment of the slit-made insulating films 50 and 60, the production of the slit-made flat cable is feasible without implementing any step additionally.

Although the step of putting the visco-elastic material 81 in the slits 80 becomes easier if it is conducted after the completion of the flat cable 30, it is also possible that the step of putting the visco-elastic 81 is incorporated into the production process of the flat cable 30.

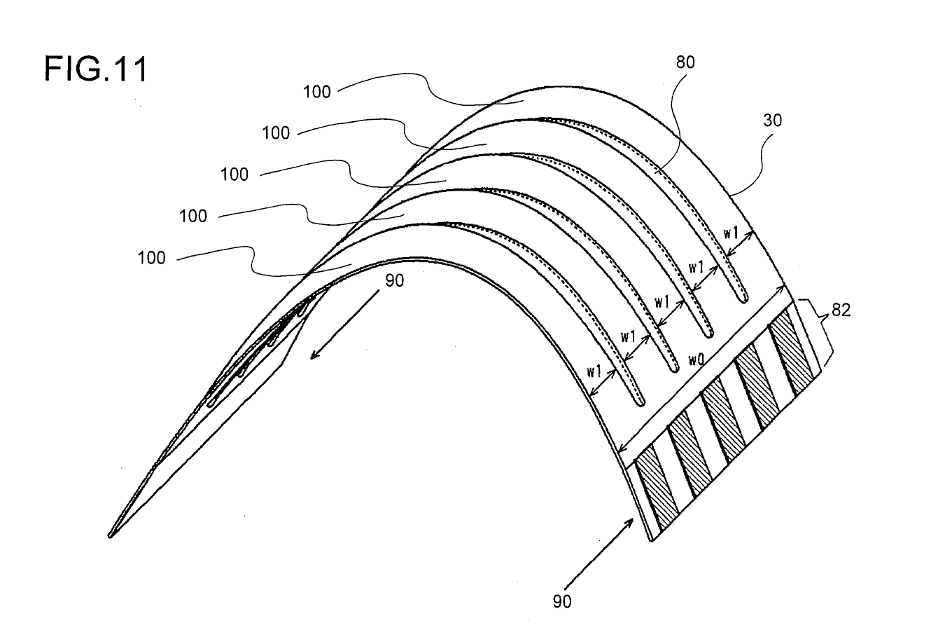

Secondly, a description will be given hereinbelow of the flexibility of the flat cable 30. FIG. 11 shows a state in which the flat wiring cable 30 is flexed in thickness directions and displaced in width directions (indicated by arrows 90).

In a case in which a simple bending stress is applied to the flat cable 30 to flex it in only thickness directions, it is easily flexible. However, when the flat cable 30 is additionally displaced in width directions (arrows 90), the length (w0) in the width direction just acts as a thickness resisting the flexing and increases its rigidity. This is equivalent to a case in which a force for making displacement (width-direction shift) is applied to a beam having a rectangular configuration in cross section. Therefore, the displacement requires a very large force.

In general, it is known that the influence of the thickness on the flexing is in inverse proportion to the third power of thickness. That is, a force corresponding to the third power of thickness is required for the same displacement. However, since the flat cable 30 is divided (divided into five portions in FIG. 11) along a width direction by the slits 80 as shown in FIGS. 10 and 11, the displacement of the flat cable is distributed to five divided flat cables 100 having a short width (w1), which reduces the rigidity against the displacement of the flat cable 30 in its width directions.

That is, the displacement of the flat cable 30 becomes the sum of displacements of the five divided flat cables 100 each having a short width (w1), and each of the flat cables 100 with the short width (w1) undergoes displacement of ⅕ of the overall displacement. The force to be applied to the flat cable 100 with the short width (w1) for that displacement can be the cube of w1. Therefore, although the displacement of the flat cable 30 requires five times as much as this force, this force is considerably smaller as compared with the force for the same displacement of the flat cable 30 with a width w0 which does not undergo the division, that is, than the third power of w0.

Concretely, assuming that a force needed for displacing the width w1 portion laterally is a (gf), the slit-divided flat cable 30 can be displaced by a force of 5×a (gf). On the other hand, in the case of a slit-absent flat cable, since the width is w0 (>5×w1), a force above 5³×a (gf) is required, which signifies twenty-five times or more as compared with the slit-divided flat cable 30.

At this deformation, the divided flat cables 100 each having a short width are deformed in a state where they overlap with each other. In other words, owing to the slits 80, the deformation of the adjacent short-width flat cables 100 can be made in an incontinuous state.

In this connection, the visco-elastic material 81 is lower in rigidity as compared with the flat cable 30 and, hence, does not exert influence substantially on the flexibility of the flat cable 30.

In addition, since the slits 80 do not extend up to the terminal portions 82 of the flat cable 30, when the flat cable 30 is deformed in its width directions, the deformation of the terminal portions 82 is preventable, thus avoiding the pitch deviation of the wiring conductors 40 and other disadvantageous events. Accordingly, there is no possibility that the workability such as soldering and corrector insertion is impaired at the connection of the flat cable 30 to equipment. Still additionally, in the case of the connection using a connector, because the deformation of the connector portion does not occur, there is no occurrence of poor contact.

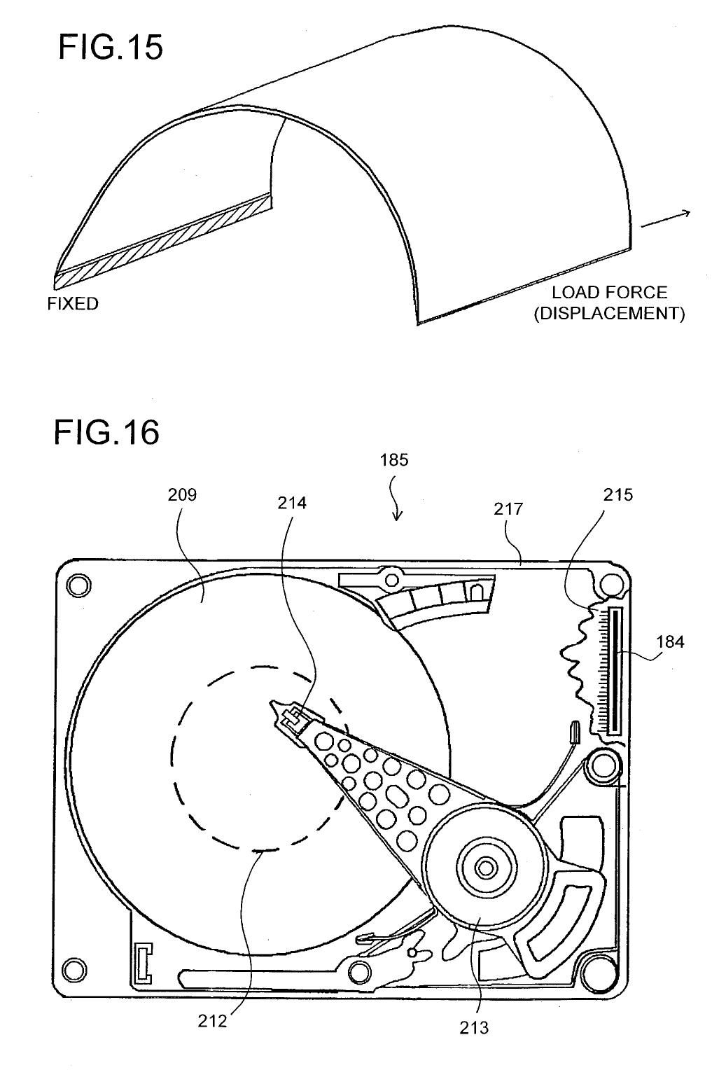

FIG. 14 shows a relationship between a displacement quantity and a load force when various flat cables are bent with a constant radius of curvature as shown in FIG. 15 and then flexed in width directions (direction indicated by an arrow in FIG. 15), where the horizontal axis represents a displacement in a width direction while the vertical axis depicts a load force therefor. In this illustration, a curve A shows the relationship therebetween in a conventional example and represents a characteristic of a flat cable having no slit, while a curve B shows the relationship therebetween in the present invention and represents a characteristic of a flat cable having slits and a curve C also shows the relationship therebetween in the present invention and represents a characteristic of a flat cable having slits, the number of which is twice as many as the number of slits in the case of the relationship line B.

As obvious from this graphic illustration, the formation of slits in a flat cable enables the flat cable to be displaced in a width direction by a lower load, which signifies an enhancement of the flexibility of the flat cable in width directions, and the flexibility becomes higher as the number of slits increases.

As described above, in a flat cable according to this embodiment, since the slits are made to enhance the flexibility in width directions (directions perpendicular to the slits) of the flat cable, even if there is a need to shift the flat cable in a width direction at the time of the connection to equipment, the flat cable can be displaced with a smaller force, thus reducing the stress to be applied to HDD or equipment, a wiring substrate or the flat cable itself.

The construction of enhancing the flexibility through the use of slits allows the reduction of the number of manufacturing steps and cost, which leads to a reduction of manufacturing cost of a flat wiring cable. Moreover, the visco-elastic maternal put in the slits can improve the damping characteristic thereof.

In addition, since the slits are disposed at a substantially equal interval in the flat cable, the flexibility in directions perpendicular to the slits can be set evenly regardless of the position in width directions, thus preventing an increase in partial stress to improve the ease of the flat cable for use and workability on the connections.

Still additionally, in the flat cable according to this embodiment, since the widths of the wiring conductors adjacent to the slits are narrowed to the slits at the adjoining portions, a predetermined spacing is defined between the slits and the wiring conductors. Therefore, in a case in which the wiring conductors are sandwiched between the upper and lower insulating films and the slits are made by means of the punching, the allowed dimension is further enlargeable with respect to the positional deviation of the slits. Yet additionally, also in a case in which slits are previously made in the upper and lower insulating films and the wiring conductors are sandwiched between the upper and lower slit-made insulating films, the enlargement of the allowed dimension is feasible, which contributes to the enhancement of the working efficiency and the suppression of lowering of the yield. Moreover, with this construction, the creepage distance between the wiring conductors and the insulating films is maintainable even at the portions adjacent to the slits, evenly with the portions with no slit, thereby preventing the lowering of the withstand voltage or the like.

(Third Embodiment)

A third embodiment of the present invention relates to a magnetic recording apparatus using a flat cable according to the second embodiment.

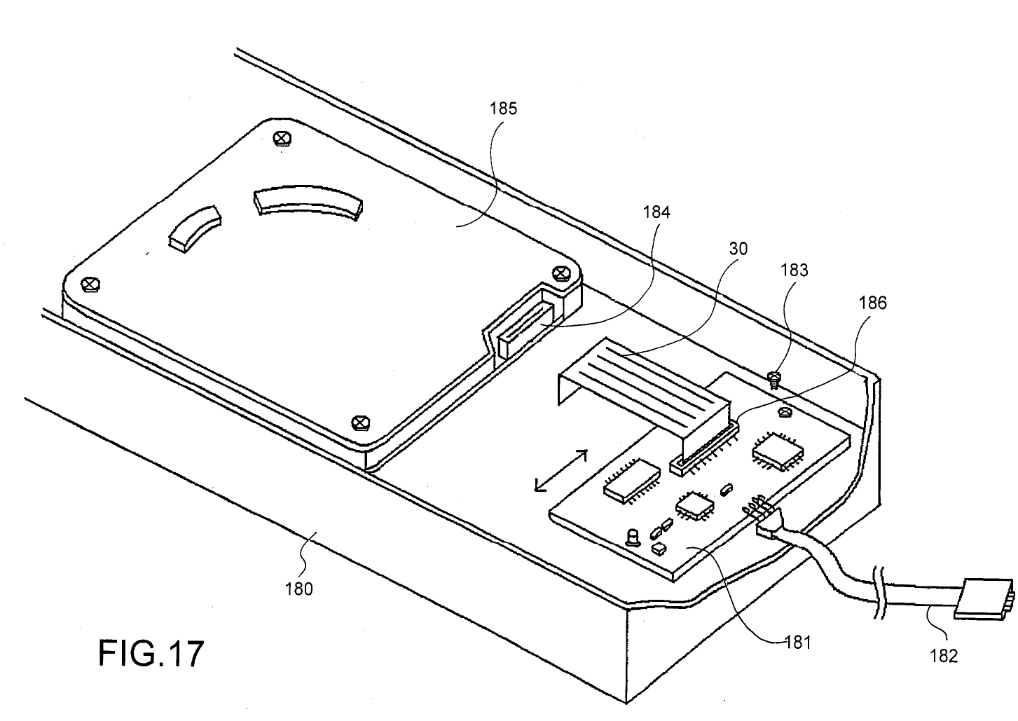

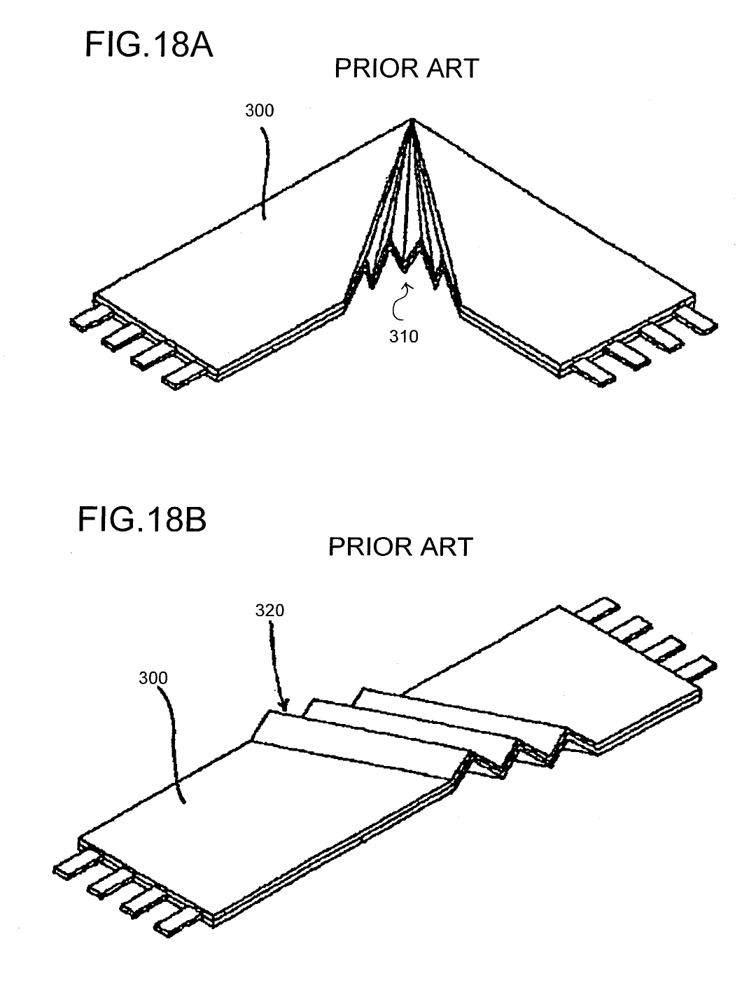

As FIG. 17 shows, this magnetic recording apparatus is made up of a magnetic recording apparatus body 185 mounted in the interior of a resin-made casing 180, a USB (Universal Serial Bus) connector 182, an I/F circuit substrate 181 for conversion of an interface signal, and a flat cable 30 for making a connection between the magnetic recording apparatus body 185 and a connector 184 (FIG. 17 shows a state before the connection between the flat cable 30 and the connector 84 of the magnetic recording apparatus body 185).

The flat cable 30 performs the interchange of electric signals between the connector 184 placed on a circuit substrate of the magnetic recording apparatus body 185 and a connector 186 placed on the I/F circuit substrate 181, and power supply thereto. In the apparatus according to this embodiment, each of the connectors 184 and 186 is of a type having conductors 40 arranged at a pitch of 0.5 mm and made such that pushing/releasing against/from a contact portion can be made through a slider at the insertion/pulling-out of the flat cable 30.

The I/F circuit substrate 181 is attached through screws 183 to the casing 180, and the magnetic recording apparatus body 185 is attached to the casing 180 by hooks (not shown) formed on the casing 180.

Moreover, as shown in FIG. 16 (where a cover is removed and a chassis is partially cut away so that a portion of circuits appears), the magnetic recording apparatus body 185 is made up of an aluminum-made base plate 217, a electric-part-packaged circuit substrate 215 (only a portion is shown in the illustration), a magnetic recording medium 209, a spindle motor 212 for rotationally driving the magnetic recording medium 209, a magnetic head 214 for carrying out the recording/reproduction of data or the like, and a voice coil motor (VCM) 213 for moving the magnetic head 214 to a desired track, with the circuit substrate 215, the spindle motor 212, the VCM 213 and others being attached to the base plate 217.

In this apparatus, there is a possibility that, depending upon the attaching accuracy of the magnetic recording apparatus body 185 and the I/F circuit substrate 181, the connector 184 and the connector 186 are shifted by a maximum of approximately 2 mm with respect to each other in width directions (indicated by arrows in FIG. 17) of the flat cable 30.

Meanwhile, in the magnetic recording apparatus body 185, a sector servo performs the positioning in track directions between a track and the magnetic head with high accuracy. If the positional deviation (called off track) in track directions between a track and the magnetic head exceeds a given limit, an readout error occurs, and in the case of the occurrence of some degree of off track, the frequency of the occurrence of error increases. For this reason, a key element is to hold down the off track to some degree. For example, this off track occurs because the base plate 217 is deformed due to, in addition to the environmental conditions such as temperature and humidity, an external force applied to the magnetic recording apparatus body 185 at the time of the fixing of the magnetic recording apparatus body 185 so that the spindle motor 212 slightly inclines to cause track eccentricity or to lead to slight positional departure between the spindle motor 212 and the VCM 213.

Likewise, the deformation of the base plate 217 occurs when an external force is applied to the circuit substrate 215. That is, an external force stemming from a width-direction deviation of the flat cable 30 connected to the connector 184 also causes the deformation thereof.

However, the flat cable 30 with slits according to the second embodiment of the present invention shows a high flexibility in width directions and, hence, without deforming the base plate 217 of the magnetic recording apparatus body 185, the connectors 184 and 186 can be connected to each other even if they are shifted from each other in a width direction.

This was confirmed through the actual measurement of the eccentricity of a track stemming from an inclination of the spindle motor 212 of the magnetic recording apparatus body 185.

In a case in which the connectors 184 and 186 were connected through a conventional flat cable to each other in a state shifted by 2 mm from each other in a width direction, the track eccentricity due to the inclination of the spindle motor 212 of the magnetic recording apparatus body 185 was approximately 40% of the track pitch. On the other hand, in the case of the employment of the flat cable 30 according to the second embodiment of the present invention, it was approximately 15%, i.e., a sufficiently low value. This can decrease the number of times of track following for each sector.

In addition, the flat cable 30 with the slits filled with a visco-elastic material 81 has a damping characteristic. When the magnetic recording apparatus receives vibrations from the external, the vibrations propagate through the casing 180 to the magnetic recording apparatus body 185 and the I/F circuit substrate 181. However, the magnetic recording apparatus body 185 and the I/F circuit substrate 181 are different in mass from each other and, hence, a phase difference appears between the vibrations of the magnetic recording apparatus body 185 and the I/F circuit substrate 181. In the flat cable 30, the visco-elastic material 81 exhibits the damping function against the phase difference. Therefore, the magnetic recording apparatus body 185 can sufficiently demonstrate the vibration-proof function. Moreover, the vibrations generated from the magnetic recording apparatus body 185 itself are also reducible, thus achieving the noise reduction.

Still additionally, in the flat cable 30 according to the second embodiment, as shown in FIGS. 12 and 13, the widths of the wiring conductors 40 adjacent to the slits 80 are narrowed to the slits 80 at the adjoining portions. In the magnetic recording apparatus, the electrical connections to the magnetic recording apparatus body 185 are made through the use of two-systems, i.e., a power supply line having a relatively large current capacity and a signal line having a relatively small current capacity. As the conductors for the power supply, one or more wiring conductors 40, which are not adjacent to the slits 80, are used for securing sufficient widths. This can lessen the voltage drop at the power supply. On the other hand, for the signal lines for transmitting signals, every wiring conductor 40 can be used irrespective of its position.

As described above, in the magnetic recording apparatus, a flat cable with slits is put to use, thus realizing a high reliability without causing a rise of manufacturing cost.

In addition, since the slits provide a high flexibility of the flat cable in width directions, even in a case in which positional deviations in longitudinal directions exists between equipment to be connected and the flat cable to be connected thereto is displaced in its width directions, less stress works on the wiring conductors. Therefore, unlike a conventional bellows structure in which there is a possibility that a corrosive stress or the like occurs because a bending stress stemming from the bending is applied, particularly, on the wiring conductors at all times, the flat cable according to the present invention can eliminate the possibility of the occurrence of a corrosive stress, thus reading to the enhancement of reliability.

Still additionally, with this flat cable according to the present invention, owing to the damping property of the visco-elastic material, the minute friction (fretting) between a connector and a terminal portion of the flat cable, which can occur due to vibrations, is also preventable. This means that the magnetic recording apparatus can be mounted in a vehicle or the like to which vibrations are applied at all times or it can be constructed as a portable apparatus, and also in these cases, a high reliability is maintainable.

It should be understood that the present invention is not limited to the above-described embodiments, and that it is intended to cover all changes and modifications of the embodiments of the invention herein which do not constitute departures from the spirit and scope of the invention.

For example, in the above description, although the flat cable according to the present invention is for use in a magnetic recording apparatus, this flat cable can be incorporated into various equipment. In this case, the interface type can properly be altered.

Moreover, in the above description, although the widths of the wiring conductors adjacent to the slits are narrowed at the adjoining portions, it is also possible that the widths of the wiring conductors are made constant provided that the slit-forming spacing between the wiring conductors is enlarged or the slit width is narrowed so that a sufficient distance is secured between the slits and the wiring conductors adjacent thereto.

What is claimed is:

1. A load torque variation preventing apparatus for a voice coil motor which rocks an actuator, supporting a magnetic head at its tip portion, around a pivot bearing, comprising:
a first flexible printed circuit whose radius of curvature varies with an angle of rotation of said actuator; and
a second flexible printed circuit which has a mechanical characteristic equivalent to that of said first flexible printed circuit and whose radius of curvature varies with an angle of rotation of said actuator,
wherein a variation of load torque around said pivot bearing, attendant upon a variation of radius of curvature of said second flexible printed circuit, offsets a variation of load torque around said pivot bearing, attendant upon a variation of radius of curvature of said first flexible printed circuit.

2. The load torque variation preventing apparatus according to claim 1, wherein said first flexible printed circuit and said second flexible printed circuit are located at positions establishing an axial-symmetrical relation with respect to a line connecting said pivot bearing with a center of a coil of said voice coil motor.

3. A magnetic disk apparatus comprising:
a magnetic disk;
a spindle motor for rotationally driving said magnetic disk;
a voice coil motor which rocks an actuator, supporting a magnetic head at its tip portion, around a pivot bearing for shifting said magnetic head toward a track of said magnetic disk with respect to a pivot bearing; and
flexible printed circuit means for supplying power to said voice coil motor and said magnetic head,
wherein said flexible printed circuit means includes:
a first flexible printed circuit whose radius of curvature varies with a track position of said magnetic head; and
a second flexible printed circuit which has a mechanical characteristic equivalent to that of said first flexible printed circuit and whose radius of curvature varies with a track position of said magnetic head, and located so that a variation of load torque around said pivot bearing, attendant upon a variation of radius of curvature of said second flexible printed circuit, offsets a variation of load torque around pivot bearing, attendant upon a variation of radius of curvature of said first flexible printed circuit.

4. The magnetic disk apparatus according to claim 3, wherein said first flexible printed circuit has a relatively wide pattern made to supply relatively large power and a relatively narrow pattern made to supply relatively small power, with said patterns being isolated from each other to define a spacing with a predetermined width.

5. The magnetic disk apparatus according to claim 4, wherein a dummy pattern is placed in said spacing so that stray capacitances existing between said relatively wide pattern and said relatively narrow pattern are connected in series to each other through said dummy pattern.

6. The magnetic disk apparatus according to claim 4, wherein a slit is made in said spacing and is filled with a visco-elastic material.

7. A flat wiring cable comprising:
a plurality of wiring conductors disposed on a plane in a parallel condition;
a flexible insulator for covering a periphery of said plurality of wiring conductors; and
a slit made to vertically pass through a portion of said flexible insulator between said wiring conductors and to horizontally extend in parallel with said wiring conductors.

8. The flat wiring cable according to claim 7, wherein said slit is filled with a visco-elastic material.

9. The flat wiring cable according to claim 7, wherein a plurality of slits each corresponding to said slit are made to be disposed at an equal interval.

10. The flat wiring cable according to claim 7, wherein each of said wiring conductors in the vicinity of said slit is made such that a width of a portion adjacent to said slit is narrower than a width of a portion which is not adjacent to said slit.

11. The flat wiring cable according to claim 10, wherein each of said wiring conductors which are not adjacent to said slit is used for supplying relatively large electric power.

12. The flat wiring cable according to claim 7, wherein said flexible insulator comprises two insulating films in which said slit is made in advance, with said wiring conductors being sandwiched between said two insulating films.

13. A magnetic recording apparatus comprising:
a flat wiring cable including:
a plurality of wiring conductors disposed on a plane in a parallel condition;
a flexible insulator for covering a periphery of said plurality of wiring conductors; and
a slit made to vertically pass through a portion of said flexible insulator between said wiring conductors and to horizontally extend in parallel with said wiring conductors.
a magnetic recording apparatus body; and
a circuit substrate for conversion of an interface signal, with said circuit substrate being connected through said flat wiring cable to said magnetic recording apparatus body.
